(19) United States
(12) Patent Application Publication
(10) Pub. No.: US 2008/0030117 A1
(43) Pub. Date: Feb. 7, 2008

(54) Field emission microelectronic device

(75) Inventors: Pi-Jin Chen, Beijing (CN); Zhao-Fu Hu, Beijing (CN); Liang Liu, Beijing (CN); Shou-Shan Fan, Beijing (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: Tsinghua University, Beijing City (CN); HON HAI Precision Industry CO., LTD., Taipei Hsien (TW)

(21) Appl. No.: 11/639,619

(22) Filed: Dec. 15, 2006

(30) Foreign Application Priority Data
Jul. 19, 2006 (CN) 200610061707.9

(51) Int. Cl. H01J 1/02; H01J 1/00; H01J 19/06

(52) U.S. Cl. 313/311; 313/495; 313/309

(57) ABSTRACT

A nano-scaled field emission electronic device includes a substrate, a first insulating layer, a second insulating layer, a film of cathode electrode, and a film of anode electrode. The second insulating layer is positioned spaced from the first insulating layer. The cathode electrode is placed on the first insulating layer and has an emitter. The anode electrode is placed on the second insulating layer and positioned opposite to the cathode electrode. The nano-scaled field emission electronic device further has at least one kind of inert gas filled therein. The following condition is satisfied: h< λ̅ₑ̅, wherein h indicates a distance between a tip of the emitter and the anode electrode, and λ̅ₑ̅ indicates an average free path of an electron in the inert gases. More advantageously, the following condition is satisfied:

$$h < \frac{\overline{{λ}_{e}}}{10} .$$

### RELATED APPLICATIONS

This application is related to commonly-assigned application entitled, “FIELD EMISSION MICROELECTRONIC DEVICE”, filed **** (Atty. Docket No. US10587), the content of which is hereby incorporated by reference thereto.

### BACKGROUND

1. Field of the Invention

The invention relates generally to field emission microelectronic devices and, more particularly, to a nano-scaled field emission electronic device, which is operated in an inert gases environment.

2. Discussion of Related Art

The invention of computers is derived from vacuum tubes. The first computer in the world includes about 18,000 vacuum tubes. In 1947, transistors were invented by Bell laboratory. Due to the characteristic of a low energy consumption and cost, easy to be mini-sized and integrated, and suitability for mass production, transistors quickly replaced the vacuum tubes in most applied fields. This replacement made the invention of microprocessors and the mass use of computers possible. However, in some special applied fields, the vacuum tubes still have some superiorities that cannot be replaced by the transistors. These superiorities can be extremely high frequency, wide dynamic range, anti-reverse breakdown, large power capability, high-temperature operation, and/or high radiation resistance.

Detailed, firstly, in an accelerated voltage of about 10 voltage, the movement velocity of electrons in the vacuum tubes is about 1.87×10⁸ cm/s, and in an electrical field of about 104V/cm, the movement velocity of electrons in the transistors is about 1.5×10⁷ cm/s. The movement velocity of the electrons in the vacuum tubes is more than that in the transistors. Thus, as long as a distance between an anode and a cathode of the vacuum tube is small enough (e.g., about 100 nanometers), the vacuum tube can be made into one device having a switching velocity much quicker than that of the transistors. Secondly, the performance of the transistors is mainly affected by the operating temperature thereof, thereby generally limiting the operating temperature to below 350° C. However, the performance of the vacuum tubes is, relatively, insensitive to the operating temperature thereof, allowing the vacuum tube to be stably operated at a relatively high temperature. Thirdly, the performance of the transistors is greatly affected by the radiation of high-energy particles, with the performance of the transistors being unstable and even potentially damaged under a relatively large radiation intensity. However, the performance of the vacuum tubes is basically insensitive to the radiation of high-energy particles, thereby permitting vacuum tube to be operated under intense radiation. The above-described superiorities make the vacuum tubes have an irreplaceable value in real-time monitoring at high temperature situations and in fields of super high-velocity communication and signal processing, such as space investigation, geological exploration, reactor inspection, steel-making, jet engines and so on.

However, conventional vacuum tubes generally have relatively large bulk and weight and thereby difficult to integrate. Thus, the conventional vacuum tubes cannot meet with the need of relatively complicated signal processing. In order to solve the shortcomings of the conventional vacuum tubes, micro vacuum tubes have been studied from the 1960's, and micro triodes have been manufactured. The operating principle of the micro vacuum tubes is similar to that of the conventional vacuum tubes, and a high vacuum degree of an inner portion of the tubes is a virtual necessity. The reason is as follows: if the residual gases therein are ionized, they would damage the performance of the tubes. Detailedly, the positive ions would add noise in the tubes, and the excessive positive ions would collide with cathode electrodes therein, thereby potentially damaging the cathode electrodes. Furthermore, the residual gases adsorbed on surface of the cathode electrodes would possibly result the unstable performance of the tubes.

In general, the better the degree of the vacuum the tubes is able to be kept in use, the better the performance thereof is. For the conventional vacuum tubes, the high vacuum degree of the inner portion thereof is kept by providing a getter in the inner portion thereof, in order to exhaust gases produced during the use process and/or residual gases during the sealing process. For the micro vacuum tubes, because the inner portion thereof is relatively small and the specific surface area thereof is relatively large, it is very difficult to keep the high vacuum degree in the inner portion thereof. This results in the micro vacuum tubes being difficult to be placed into practice.

What is needed, therefore, is a nano-scaled field emission electronic device which is operated in inert gases, the nano-scaled field emission electronic device having a superior performance and range of applications, and satisfactory vacuum maintenance.

### SUMMARY

In one embodiment, a nano-scaled field emission electronic device includes a substrate, a first insulating layer, a second insulating layer, a film of cathode electrode, and a film of anode electrode. The second insulating layer is positioned spaced from the first insulating layer. The cathode electrode is placed on the first insulating layer and has an emitter. The anode electrode is placed on the second insulating layer and positioned opposite to the cathode electrode. The nano-scaled field emission electronic device further has at least one kind of inert gases filled therein. The following condition is satisfied: h< λ̅ₑ̅, wherein h indicates a distance between a tip of the emitter and the anode electrode, and λ̅ₑ̅ indicates an average free path of an electron in the inert gases.

Other advantages and novel features of the present nano-scaled field emission electronic device will become more apparent from the following detailed description of preferred embodiments when taken in conjunction with the accompanying drawings.

### BRIEF DESCRIPTION OF THE DRAWINGS

Many aspects of the present nano-scaled field emission electronic device can be better understood with reference to the following drawings. The components in the drawings are not necessarily to scale, the emphasis instead being placed upon clearly illustrating the principles of the present nano-scaled field emission electronic device.

FIG. 1 is a cross-sectional view of a nano-scaled field emission electronic device, in accordance with a first embodiment of the present device;

FIG. 2 is a cross-sectional view of a nano-scaled field emission electronic device, in accordance with a second embodiment of the present device; and

FIG. 3 is a cross-sectional view of a nano-scaled field emission electronic device, in accordance with a third embodiment of the present device.

FIG. 4 is a cross-sectional view of a nano-scaled field emission electronic device, in accordance with a fourth embodiment of the present device.

Corresponding reference characters indicate corresponding parts throughout the several views. The exemplifications set out herein illustrate at least one preferred embodiment of the present nano-scaled field emission electronic device, in at least one form, and such exemplifications are not to be construed as limiting the scope of the invention in any manner.

### DETAILED DESCRIPTION OF PREFERRED EMBODIMENTS

Reference will now be made to the drawings to describe embodiments of the present nano-scaled field emission electronic device, in detail.

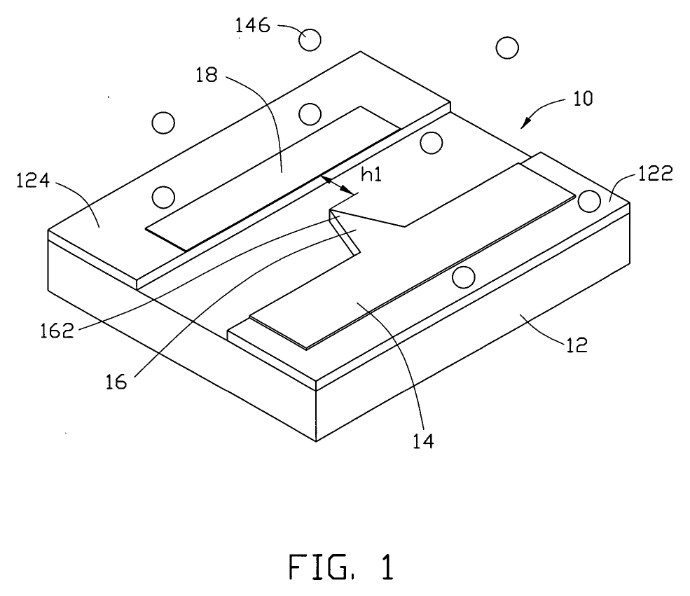

FIG. 1 shows a nano-scaled field emission electronic device 10, in accordance with a first embodiment of the present device. As shown in FIG. 1, the nano-scaled field emission electronic device 10 is a thin-film bipolar structure and includes a substrate 12, a first insulating layer 122, a second insulating layer 124, a film of cathode electrode 14, and a film of anode electrode 18. The first insulating layer 122 and the second insulating layer 124 are respectively positioned (i.e., essentially directly deposited, which is intended to incorporate both direct attachment thereof or attachment via one or more thin, adhesion-promotion layers) on the substrate 12 and spaced from each other. The cathode electrode 14 is positioned (i.e., essentially directly deposited) on the first insulating layer 122 and has an emitter 16. The emitter 16 extends beyond the first insulating layer 122, such that a free gap exists between the emitter 16 and the substrate 12, the gap promoting free operation of the emitter 16 (i.e., no interference by the insulating substrate 12). It is, however, understood that the emitter 16 may also be directly positioned on the first insulating layer 122, for ease of manufacture and in order to provide greater mechanical support for the emitter 16. The emitter 16 has an emission tip 162, and the emission tip 162 faces the anode electrode 18. The anode electrode 18 is positioned (i.e., essentially directly deposited) on the second insulating layer 124 and apart from the cathode electrode 14. A distance between the emission tip 162 of the emitter 16 and the anode electrode 18 is labeled as h1 and is named as a feature size (i.e., an emission distance) of the nano-scaled field emission electronic device 10.

A plurality of inert gas atoms 146, together referred to as an inert gas, is sealed in the field emission electronic device 10. A pressure of the inert gas 146 is in the range from about 0.1 to about 10 atmospheric pressure (i.e., unit of atmospheres). Preferably, the pressure of the inert gas 146 is about one atmospheric pressure. The inert gas 146 can be selected from the group consisting of helium (He), neon (Ne), argon (Ar), krypton (Kr), xenon (Xe), and a mixture of such gases thereof. Preferably, the inert gas 146 is helium. Furthermore, the following condition is satisfied: h1< λ̅ₑ̅, wherein h1 indicates the feature size (i.e., the emission distance) of the nano-scaled field emission electronic device 10, and λ̅ₑ̅ indicates an average free path of an electron in the inert gas atoms 146.

From the above description, the nano-scaled field emission electronic device 10 operates in the presence of the inert gas 146 and the feature size hi thereof is relatively small. As such, the nano-scaled field emission electronic device 10 has the following advantages. Firstly, the relatively small feature size h1 ensures that probability of collision of electrons emitted by the emitter 16 with atoms of the inert gases 146 is relatively small when the electrons move to the anode electrode 18. When the feature size h1 of the electron in the inert gas 146 is far smaller than the free path λ̅ₑ̅ of the electron in the inert gas 146, the electrons will rarely collide with the atoms of the inert gas 146. At this state, it can be considered that the electrons can get to the anode electrode 18 essentially freely. Preferably, as such, the feature size h1 is smaller than tenth of the free path λ̅ₑ̅ of the electron in the inert gas 146 (i.e.,

$$h < \frac{\overline{{λ}_{e}}}{10} ) .$$

Detailedly, the free path λ̅ₑ̅ of the electron in the inert gases can be expressed as follows:

$$\overline{{λ}_{e}} = \frac{4}{π n {σ}^{2}} = \frac{4 kT}{{πσ}^{2} p} ,$$

wherein n indicates a density of the inert gases; σ indicates an effective diameter of molecules of the inert gases; k indicates the Boltzmann constant, and the value thereof is equal to 1.38×10⁻²³ J/K; T indicates an absolute temperature of the inert gas; and p indicates a pressure of the inert gas. Detailedly, at one atmospheric pressure, and when the absolute temperature T of the inert gas is equal to 300K, the free paths of the electron in different kinds of inert gases is expressed in the following Table 1:

TABLE 1

| inert gas | He | Ne | Ar | Kr | Xe |
|---|---|---|---|---|---|
| σ (10⁻¹⁰ m) | 2.18 | 2.6 | 3.7 | 4.2 | 4.9 |
| λ̅ₑ̅ (μm) | 1.07 | 0.77 | 0.38 | 0.29 | 0.22 |

In the preferred embodiment, the inert gas 146 is helium. When the nano-scaled field emission electronic device 10 includes helium gas 146 at one atmospheric pressure, as long as the feature size h1 is far smaller than the free path λ̅ₑ̅ (i.e., 1.07 μm) of the electron in the helium gas 146, the electrons nearly don't (i.e., rarely) collide with the atoms of the helium gas 146 and can likely get to the anode electrode 18 freely. Furthermore, as shown in the following Table 2, when the feature size h1 is smaller than one tenth of the free path λ̅ₑ̅ of the electron in the helium gas 146 (i.e., 107 nm), about 91 percent of the electrons emitted by the emitter 16 don't collide with the atoms of the helium gas 146 and can get to the anode electrode 18 freely.

TABLE 2

| feature size | 0.01 λ̅ₑ | 0.1 λ̅ₑ | 1 λ̅ₑ | 5 λ̅ₑ | 10 λ̅ₑ |
|---|---|---|---|---|---|
| probability of free moving | 0.99 | 0.91 | 0.37 | 0.007 | 4.5 × 10⁻⁵ |

Secondly, because the feature size h1 of the nano-scaled field emission electronic device 10 is smaller than the free path λ̅ₑ̅ of the electron in the helium gas 146, that is, the distance between the emission tip 162 of the emitter 16 and the anode electrode 18 is relatively small, an emission voltage needed by the nano-scaled field emission electronic device 10 to emit electrons is also relatively small. Thus, an amount of energy obtained by the electrons from the emission voltage is relatively low. When the obtained energy of the electrons is smaller than the first ionization energy of the inert gas 146, the atoms of the inert gas 146 would not be ionized by an electron of such a energy. When the obtained energy of the electrons is equal to or only a little greater than the first ionization energy of the inert gas 146, the ionization ratio of the atoms of the inert gases 146 is relatively low or even can be ignored. Table 3 shows the first ionization energy of different kinds of inert gases. Thus, in the preferred embodiment, even if the electrons emitted by the emitter 16 would collide with the atoms of the inert gas 146, the atoms of the inert gas 146 would, most likely, not be ionized.

TABLE 3

| inert gas | He | Ne | Ar | Kr | Xe |
|---|---|---|---|---|---|
| first ionization | 24.587 | 21.564 | 15.759 | 13.999 | 12.130 |
| energy (eV) | | | | | |

Thirdly, because the nano-scaled field emission electronic device 10 includes the inert gas 146, the atoms of inert gas 146 not only would not be adsorbed on a surface of the emitter 16 (i.e., due to the inert nature thereof), but such atoms also can continue to bombard the emitter 16 due to the kinetic energy thereof. This bombardment can remove molecules of impurity gases adsorbed on the emitter 16 during the manufacturing process and so on. This removing can clean the emitter in a certain extent and can help the nano-scaled field emission electronic device 10 to run/operate stably.

Detailedly, the bombardment frequency of the molecules of the gases on a per unit area of the device can be expressed as follows:

$$υ = \frac{1}{4} n \overline{υ} = \frac{p}{\sqrt{2 π {m}_{0} kT}} = \frac{p \cdot {N}_{A}}{\sqrt{2 π MRT}} ,$$

wherein n indicates a density of the molecules of the gas; υ̅ indicates an average speed produced by the kinetic energy of the molecules/atoms of the gas; p indicates a pressure of the gas; M indicates an atomic weight of the gas; N_{A} indicates Avogadro constant, and the value thereof is equal to 6.02×10²³ mol⁻¹; T indicates an absolute temperature of the gases; and R is equal to 8.31 J/(mol·K).

In the preferred embodiment, the nano-scaled field emission electronic device 10 is at work at a temperature of about 300K and includes helium gas 146 of one atmospheric pressure, the bombardment frequency of the molecules of the helium gas 146 on per unit area of the emitter 16 of the nano-scaled field emission electronic device 10 is about 7.7×10²⁷/m² s. An area of one molecule of the impurity gases, such as water vapor adsorbed on the emitter 16 is about 10⁻¹⁹ m², and, thus, the bombardment frequency to the water vapor is about 7.7×10⁸/s. The above-described bombardment frequency is relatively high, thereby having a strong cleaning effect. This strong cleaning effect can keep the emitter 16 from being adsorbed by the atoms of the impurity gases and ensure the good field emission performance of the emitter 16.

The substrate 12 is, advantageously, made of the semiconductor material selected from the group consisting of silicon (Si), germanium (Ge), gallium nitride (GaN), and diamond. The first insulating layer 122 and the second insulating layer 124 are, beneficially, made of the insulating material selected from the group consisting of silicon dioxide (SiO₂) and silicon nitride (Si₃N₄). The anode electrode 18 is advantageously made of a high-temperature oxidation-resistant metal material selected from the group consisting of gold (Au), platinum (Pt), silver (Ag), titanium (Ti), copper (Cu), aluminum (Al), tungsten (W), molybdenum (Mo), tantalum (Ta), rhenium (Re), niobium (Nb), nickel (Ni), chromium (Cr), zirconium (Zr), and/or hafnium (Hf). Alternatively, the anode electrode 18 could be made of a semiconductor material selected from the group consisting of silicon (Si), germanium (Ge), and gallium nitride (GaN). Still alternatively, the anode electrode 18 could be made of the above-mentioned semiconductor material with the above-mentioned metal material coated thereon. The cathode electrode 14 is beneficially made of the same material as that of the anode electrode 18.

The emitter 16 is a micro-tip structure, usefully made of the same material as that of the cathode electrode 14. Furthermore, the emitter 16 has a film of a low work function material deposited thereon. The low work function material can be a metal boride, such as lanthanum hexaboride (LaB₆), and/or a rare earth oxide, such as lanthanum oxide (La₂O₃), yttrium oxide (Y₂O₃), gadolinium oxide (Gd₂O₃), and/or dysprosium oxide (Dy₂O₃). Alternatively, the cathode electrode 14 can be a film sintered to include one or more materials chosen from the group of the above-mentioned rare earth oxides, carbides, and metals with a relatively high melting point. The carbides can be thorium carbide, zirconium carbide, titanium carbide, tantalum carbide and so on. The metals with the relatively high melting point can be, e.g., tungsten (W), molybdenum (Mo), niobium (Nb), rhenium (Re), platinum (Pt), and so on. Still alternatively, the emitter 16 can, further advantageously, have a carbon nanotube or a semiconductor nanowire attached on one of the above-described micro-tip structures. It is understood that the carbon nanotube or the semiconductor nanowire could instead be directly formed on the cathode electrode 14 to act as the emitter 16.

In use, a field emission voltage is provided between the cathode electrode 14 and the anode electrode 18, and the surface-barrier of the emission tip 162 of the emitter 16 is decreased and narrowed in the effect of the electric field formed by the field emission voltage. When the surface-barrier of the emission tip 162 of the emitter 16 is narrowed to a thickness similar to the wavelength of the electrons, the electrons penetrate the surface-barrier of the emission tip 162 of the emitter 16, due to the tunneling effect. By this process, the emission of the electrons is thereby achieved.

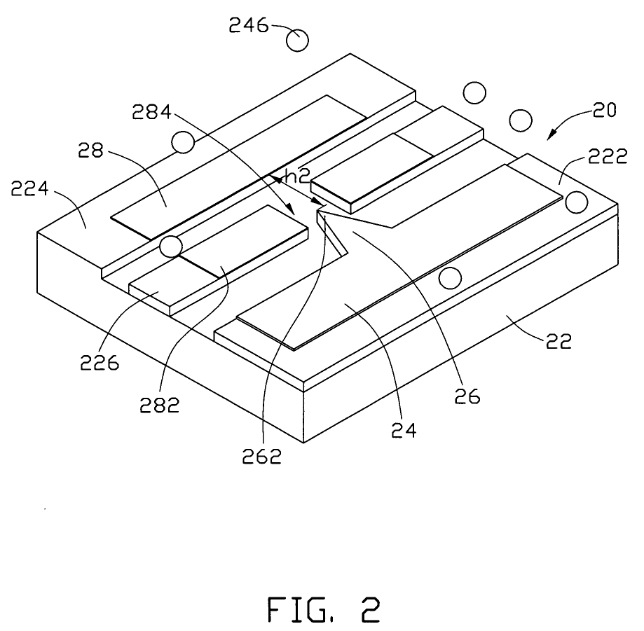

Referring to FIG. 2, a nano-scaled field emission electronic device 20 in accordance with a second embodiment of the present device, is shown. The nano-scaled field emission electronic device 20 is a thin-film triode structure and includes a substrate 22, a first insulating layer 222, a second insulating layer 224, a third insulating layer 226, a film of cathode electrode 24, a film of grid electrode 282 and a film of anode electrode 28. The first insulating layer 222 and the second insulating layer 224 are positioned on the substrate 22 and spaced from each other. The third insulating layer 226 is positioned on the substrate 22 and spaced between the first insulating layer 222 and the second insulating layer 224. The cathode electrode 24 is positioned on the first insulating layer 222 and has an emitter 26. The emitter 26 has an emission tip 262, and the emission tip 262 faces the anode electrode 28. The anode electrode 28 is positioned on the second insulating layer 224 and apart (i.e., spaced) from the cathode electrode 24. The grid electrode 282 is positioned on the third insulating layer 226 apart from the cathode electrode 24 and the anode electrode 28. A plurality of inert gas atoms 246, collectively considered to establish an inert gas 246, is sealed in the field emission electronic device 20. The third insulating layer 226 and the grid electrode 282 have an opening 284 corresponding to the emission tip 262 of the emitter 26. Furthermore, a distance h2 between the emission tip 262 of the emitter 26 and the anode electrode 28 (i.e., a feature size or emission distance of the nano-scaled field emission electronic device 20) is smaller than an average free path of an electron in the inert gas 246.

The nano-scaled field emission electronic device 20 is similar to the nano-scaled field emission electronic device 10, except that the nano-scaled field emission electronic device 20 is a triode and further includes the grid electrode 282 positioned on the third insulating layer 226. The material of the substrate 22, cathode electrode 24, emitter 26, and anode electrode 28 in the second embodiment is as same as that of the substrate 12, cathode 14, emitter 16 and anode electrode 18 in the first embodiment respectively. The material of the grid electrode 282 is as same as that of the anode electrode 28. The material of the third insulating layer 226 is as same as that of the first insulating layer 222 and the second insulating layer 224. The potential gases for the inert gas 246 in the second embodiment are the same as the inert gas 146 in the first embodiment. In use, a controlling voltage is provided on/across the grid electrode 282 to control the emitter 26 to selectably emit electrons. Furthermore, a voltage is provided on/across the anode electrode 28 to ensure the electrons quickly reach the anode electrode 28.

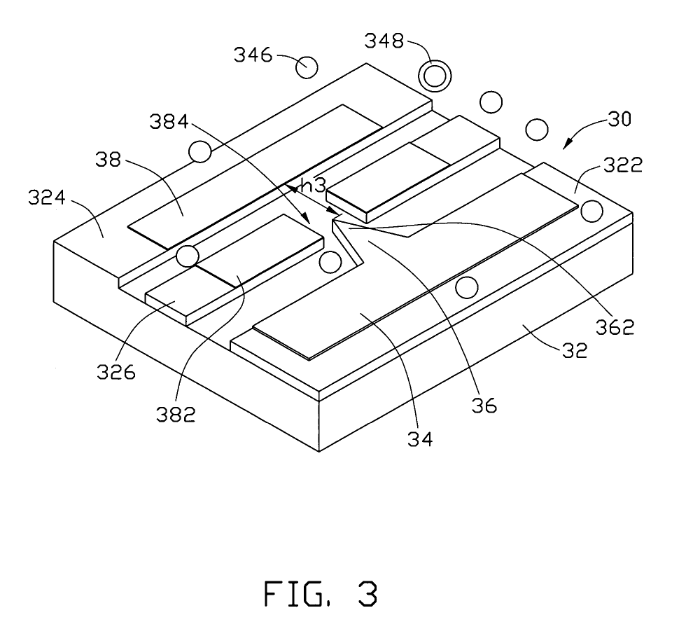

Referring to FIG. 3, a nano-scaled field emission electronic device 30, in accordance with a third embodiment of the present device, is shown. The nano-scaled field emission electronic device 30 is a thin-film triode structure and includes a substrate 22, a first insulating layer 322, a second insulating layer 324, a third insulating layer 326, a film of cathode electrode 34, a film of grid electrode 382 and a film of anode electrode 38. The first insulating layer 322 and the second insulating layer 324 are positioned on the substrate 32 and spaced from each other. The third insulating layer 326 is positioned on the substrate 32 and spaced between the first insulating layer 322 and the second insulating layer 324. The cathode electrode 34 is positioned on the first insulating layer 322 and has an emitter 36. The emitter 36 has an emission tip 362, and the emission tip 362 faces the anode electrode 38. The anode electrode 38 is positioned on the second insulating layer 324 and apart from the cathode electrode 34. The grid electrode 382 is positioned on the third insulating layer 326 apart from the cathode electrode 34 and the anode electrode 38. A plurality of inert gas atoms 346, 348 is sealed in the field emission electronic device 30. The third insulating layer 326 and the grid electrode 382 have an opening 384 corresponding to the emitter 36. Furthermore, a distance h3 between the emission tip 362 of the emitter 36 and the anode electrode 38 (i.e., a feature size or emission distance of the nano-scaled field emission electronic device 30) is smaller than an average free path of an electron in the inert gases 346, 348.

The nano-scaled field emission electronic device 30 is similar to the nano-scaled field emission electronic device 20, except that at least two different kinds of inert gases 346, 348 are sealed in the field emission electronic device 30. In the third embodiment, for illustration purposes, the inert gas 346 is helium (He), and the inert gas 348 is neon (Ne). The helium gas 346 can enhance the free path of the electrons, and this enhanced free path reduces the requirement to the feature size h3 of the nano-scaled field emission electronic device 30, allowing for a larger emission distance h3 to be chosen, if desired. Furthermore, the atomic weight of the neon gas 348 is relatively large, and this atomic size ensures that the neon gas 348 has a better ability to clean the surface of the emitter 36 and remove impurity gases absorbed on the emitter 36.

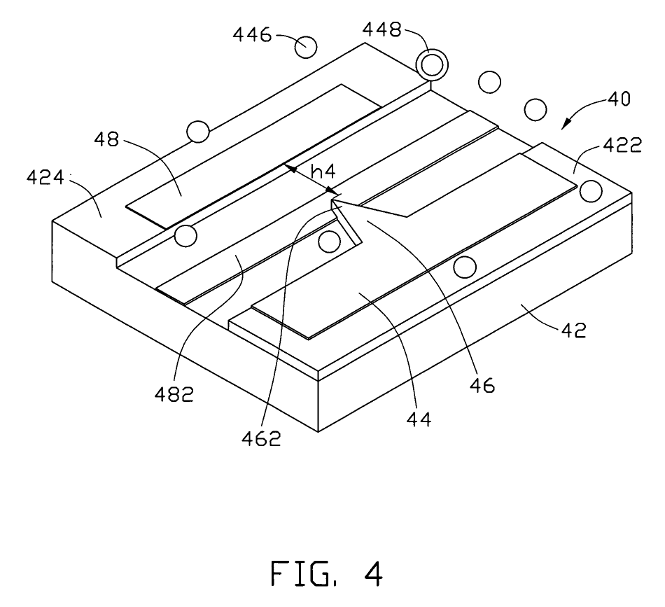

Referring to FIG. 4, a nano-scaled field emission electronic device 40, in accordance with a fourth embodiment of the present device, is shown. The nano-scaled field emission electronic device 40 is a thin-film triode structure and includes a substrate 42, a first insulating layer 422, a second insulating layer 424, a film of cathode electrode 44, a film of grid electrode 482 and a film of anode electrode 48. The first insulating layer 422 and the second insulating layer 424 are positioned on the substrate 42 and spaced from each other. The cathode electrode 44 is positioned on the first insulating layer 422 and has an emitter 46. The emitter 46 has an emission tip 462, and the emission tip 462 faces the anode electrode 48. The anode electrode 48 is positioned on the second insulating layer 424 and apart from the cathode electrode 44. The grid electrode 482 is positioned on the substrate 42 and spaced between the cathode electrode 44 and the anode electrode 48. The grid electrode 482 is positioned between the substrate 42 and the emitter 46. A plurality of inert gas atoms 446, 448 is sealed in the field emission electronic device 40. Furthermore, a distance h4 between the emission tip 462 of the emitter 46 and the anode electrode 48 (i.e., a feature size of the nano-scaled field emission electronic device 40) is smaller than an average free path of an electron in the inert gas atoms 446, 448.

It can be understood that the nano-scaled field emission electronic device 10 in accordance with the first embodiment, can also has at least two different kinds of inert gases sealed therein. The inert gases with a relatively large atomic weight has a better ability for cleaning the surface of the emitter 16 and removing impurity gases absorbed on the emitter 16, and the inert gases with a relatively small atomic weight can enhance the free path of the electrons in the sealed space 144, thereby reducing the requirement to the feature size h1 (i.e., actually allowing a potential increase in the size thereof) of the nano-scaled field emission electronic device 10.

It can be further understood that the nano-scaled field emission electronic devices in accordance with the embodiments can be manufactured by means of e-beam lithography cooperating with dry etching, wet etching, and/or vacuum coating. The encapsulation of the nano-scaled field emission electronic devices can be executed by evacuating the devices and then filling the inert gases in the devices. Alternatively, the nano-scaled field emission electronic devices can be encapsulated in the circumstance of the flowing inert gases. This encapsulation process does not need the step of evacuating, thereby enhancing the manufacture efficiency and reducing the manufacture cost. Furthermore, the bipolar nano-scaled field emission electronic devices 10 and the triode nano-scaled field emission electronic devices 20, 30, 40 can be integrated on one substrate. This integration forms an integrated circuit that can achieve the management and operation of the relatively complex signals.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

We claim:

1. A nano-scaled field emission electronic device comprising:
a substrate;
a first insulating layer placed on the substrate;
a second insulating layer placed on the substrate and spaced from the first insulating layer;
a cathode electrode placed on the first insulating layer and having an emitter, the emitter having a tip;
an anode electrode placed on the second insulating layer and positioned opposite to and spaced from the cathode electrode; and
at least one inert gas material provided between the cathode and the anode, the at least one inert gas material collectively establishing an inert gas, the following condition being satisfied: h< λ̅ₑ̅, wherein h indicates a distance between the tip of the emitter and the anode electrode, and λ̅ₑ̅ indicates an average free path of electrons in the inert gas.

2. The nano-scaled field emission electronic device as claimed in claim 1, further comprising a grid electrode positioned between the cathode electrode and the anode electrode.

3. The nano-scaled field emission electronic device as claimed in claim 2, further comprising a third insulating layer positioned between the grid electrode and the substrate.

4. The nano-scaled field emission electronic device as claimed in claim 3, wherein the grid electrode and the third insulating layer each include an opening corresponding to the emitter of the cathode electrode.

5. The nano-scaled field emission electronic device as claimed in claim 2, wherein the grid electrode is placed on the substrate.

6. The nano-scaled field emission electronic device as claimed in claim 1, wherein the emitter comprises a micro-tip structure.

7. The nano-scaled field emission electronic device as claimed in claim 6, wherein the emitter is comprised of a material selected from a group consisting of silicon, molybdenum, and tungsten.

8. The nano-scaled field emission electronic device as claimed in claim 7, wherein the emitter has a film coated thereon, the film being comprised of a material with a lower work function than that of the emitter.

9. The nano-scaled field emission electronic device as claimed in claim 6, wherein the emitter is comprised of at least one material selected from a group consisting of rare-earth oxides; carbides; and metals with relatively high melting points.

10. The nano-scaled field emission electronic device as claimed in claim 6, wherein the emitter has at least one carbon nanotube or semiconductor nanowire assembled thereon.

11. The nano-scaled field emission electronic device as claimed in claim 1, wherein the emitter is selected from a group consisting of a carbon nanotube, a semiconductor nanowire, and an array thereof.

12. The nano-scaled field emission electronic device as claimed in claim 1, wherein a pressure of the at least one inert gas material is in the approximate range from 0.1 to 1 atmosphere pressure.

13. The nano-scaled field emission electronic device as claimed in claim 1, wherein the at least inert gas material is selected from a group consisting of helium (He), neon (Ne), argon (Ar), krypton (Kr), xenon (Xe), and a mixture thereof.

14. The nano-scaled field emission electronic device as claimed in claim 1, wherein the following condition is further satisfied:
$$h < \frac{\overline{{λ}_{e}}}{10} ,$$
wherein h indicates the distance between the tip of the emitter and the anode electrode, and λ̅ₑ̅ indicates the average free path of the electrons in the inert gas.

15. The nano-scaled field emission electronic device as claimed in claim 1, wherein the average free path λ̅ₑ̅ of the electron in the inert gases can be expressed as follows:
$${\overline{λ}}_{e} = \frac{4}{π n {σ}^{2}} = \frac{4 kT}{{πσ}^{2} p} ,$$
wherein n indicates a density of the inert gases; σ indicates an effective diameter of molecules of the inert gases; k indicates the Boltzmann constant, and the value thereof is equal to 1.38×10⁻²³ J/K; T indicates an absolute temperature of the inert gas; and p indicates a pressure of the inert gas.

16. The nano-scaled field emission electronic device as claimed in claim 1, wherein an emission voltage between the cathode and the anode is a voltage required to achieve emission of electrons from the emitter, the distance h permitting that an amount of energy obtained by the electrons from the emission voltage is able to be less than or equal to about a first ionization energy of each inert gas material.

17. The nano-scaled field emission electronic device as claimed in claim 1, wherein the at least one inert gas material has a kinetic energy associated therewith, the at least one inert gas material thereby being able to bombard the emitter and potentially remove molecules of impurity gases adsorbed on the emitter.
